(19) United States
(12) Patent Application Publication
(10) Pub. No.: US 2012/0116771 A1
(43) Pub. Date: May 10, 2012

(54) Method and apparatus for serching a music database

(76) Inventor: Jill A. Pandiscio, Wayland, MA (US)

(21) Appl. No.: 13/200,742

(22) Filed: Sep. 28, 2011

Related U.S. Application Data
(63) Continuation of application No. 12/137,461, filed on Jun. 11, 2008, now abandoned.
(60) Provisional application No. 60/934,115, filed on Jun. 11, 2007.

(51) Int. Cl. G10L 11/00

(52) U.S. Cl. 704/270; 704/E11.001

(57) ABSTRACT

A method for a user to buy a song from a remote music source, the method comprising the steps of:
the user inputting a song melody into an input device connected to the remote music source, wherein the user inputs the song melody using only their mouth;
processing the tones of the input song melody so as to determine a set of tonal characteristics associated with the input tones;
searching a music database for a song having a like set of tonal characteristics, so as to return at least one candidate song title to the user;
playing a sample of the song associated with the at least one candidate song title for the user;
permitting the user to purchase the song associated with the at least one candidate song title if desired; and
delivering a purchased song to the user via a digital transmission medium.

### REFERENCE TO PENDING PRIOR PATENT APPLICATION

This patent application claims benefit of pending prior U.S. Provisional Patent Application Ser. No. 60/934,115, filed Jun. 11, 2007 by Jill A. Pandiscio for METHOD AND APPARATUS FOR SEARCHING A MUSIC DATABASE (Attorney's Docket No. JILL-1 PROV), which patent application is hereby incorporated herein by reference.

### FIELD OF THE INVENTION

This invention relates to methods and apparatus for searching databases in general, and more particularly to methods and apparatus for searching music databases.

### BACKGROUND OF THE INVENTION

Traditionally, music has been purchased on physical media, i.e., at one time music was purchased on vinyl records and in tape cassettes, and more recently it has been purchased on compact discs (CDs). Increasingly, however, people are turning to a new form of music sales, namely, on-line purchasing.

More particularly, on-line purchasing is effected electronically, typically by using Web-based music programs such as iTunes™ or Napster™. The user opens the on-line music program (e.g., iTunes™ or Napster™) and then enters the title of the desired song into a search box. The on-line music program (e.g., iTunes™ or Napster™) then handles the on-line sale and downloads the desired song to the user's computer.

However, what happens when the user cannot remember the title of the song? In this case the on-line music program's search box is effectively useless. The user is left with only a fleeting tune in their head and nothing to search. Those who remember some of the lyrics, and who are motivated enough, might turn to Google™ and/or another search engine and type in any fragments of the lyrics that they manage to remember. In some cases the user may be lucky and have remembered enough of the lyrics for the search engine to ultimately find the song title, albeit after a time-consuming effort on the user's part. However, in many cases the user will not remember the lyrics at all, or will not remember enough of the lyrics for the search engine to return reasonably accurate results, or will not have the time and/or inclination to use the search engine, etc.

As a result, many music sales are lost due to the disconnect between a willing purchaser and the knowledge needed to effectively access the music database.

### BRIEF DESCRIPTION OF THE DRAWINGS

These and other objects and features of the present invention will be more fully disclosed or rendered obvious by the following detailed description of the invention, which is to be considered together with the accompanying drawings wherein like numbers refer to like parts, and further wherein:

FIG. 1 is a schematic drawing of an apparatus for identifying a song; and

FIG. 2 is a schematic drawing of another apparatus for identifying a song.

### SUMMARY OF THE INVENTION

But, what if the user could sing (or hum or whistle, for those who are more musically challenged) the song melody into the on-line music program (e.g., iTunes™ or Napster™) and have the music program use that input melody to tell the user what that song is that the user has been longing to buy? This would solve all of the problems discussed above, and significantly facilitate on-line sales of music.

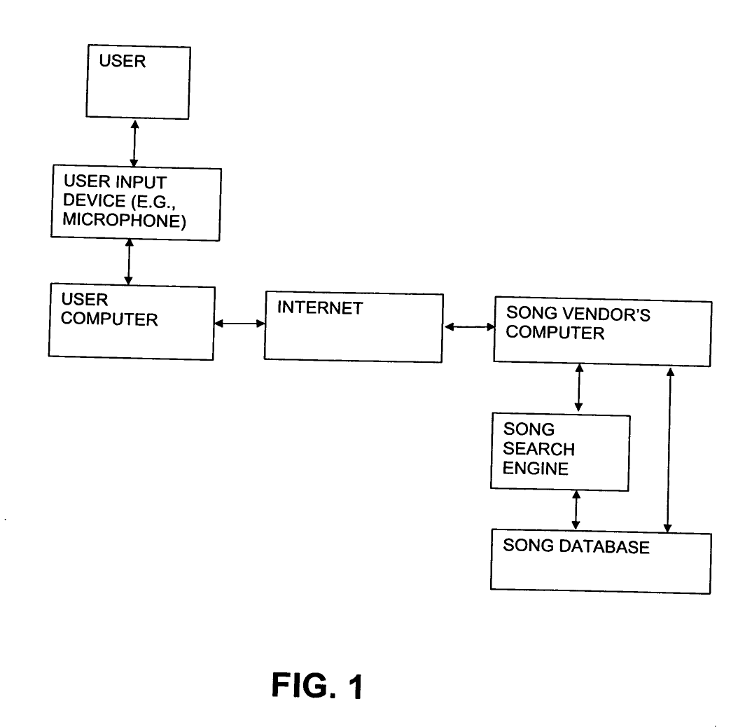

In other words, with this new approach, and looking now at FIG. 1, the user would simply sing, hum or whistle a song melody into a microphone connected to their computer, and this melody would then be transmitted over the Internet to the on-line music program (e.g., iTunes™ or Napster™). The on-line music program would then determine the arrangement of the notes input into the microphone, and search a music database for the identified note arrangement, eventually returning a title for the selected song. The program would then ask the user to listen to a brief sample of the song to confirm that the correct song has been identified using the input song melody. If the identified song is the desired one, the user can then proceed to purchase the song and download it to their computer. If the identified song is not the desired one, the user can try re-entering the song melody to see if a more accurate result can be achieved.

The on-line music program may process the specific tones input by the user, and then search the music database for a match against the input tones, in a variety of ways.

By way of example but not limitation, the on-line music program may process the specific tones of the input melody by first identifying each input tone in the context of an absolute note scale, then assembling an array of these successive absolute-scale notes, and then comparing the assembled array of absolute-scale notes against a song database where each song is represented by an array of notes defined in the context of the same absolute note scale. For example, the absolute note scale could be “the conventional Western musical note scale”, where notes are represented as C, C#, D, D#, E, F, F#, G, G#, A, A# and B. In this system, the specific tones input by the user might first be reduced to an array of these absolute-scale notes (e.g., C, C, C, F#, G, B, C, etc.) and then this array compared against a database of songs represented in the same format of absolute-scale notes.

By way of further example but not limitation, the system can reduce the input tones of the song melody to their absolute frequency (e.g., X kHz, Y kHz, Z kHz, etc.), then build an array of these absolute-frequency values, and then compare the array of absolute-frequency values against a database where each song is represented in the same format of absolute-frequency values.

By way of further example but not limitation, the system can reduce the input tones of the song melody so that each successive note is represented as a rise (+), fall (−) or repeat (=) of the frequency of immediately-preceding note, then build an array of these comparative frequency changes, and then compare this data array against a song database where the songs are held in a similar format, e.g., the input tones might be reduced to an array consisting of (+, −, +, −, =, =, etc.), and then this array compared against a database of songs represented in a similar format

In some cases, the song melody input into the microphone might not be sufficient for the search engine to return a single song title. One reason for this could be that the song melody input by the user might be identified with a number of different songs (e.g., different songs by different composers which share a highly similar melody segment). Another reason for this is that the song melody input by the user might be identified with a single song, but there might be numerous renditions of the same song, e.g., by different artists. In either case, the search engine can present the user with a list of candidate songs, and the user can listen to song clips of the various alternatives so as to narrow down the selection to the correct song. Once the user has determined that the correct song has been identified, the song can be purchased and then downloaded to the user's computer.

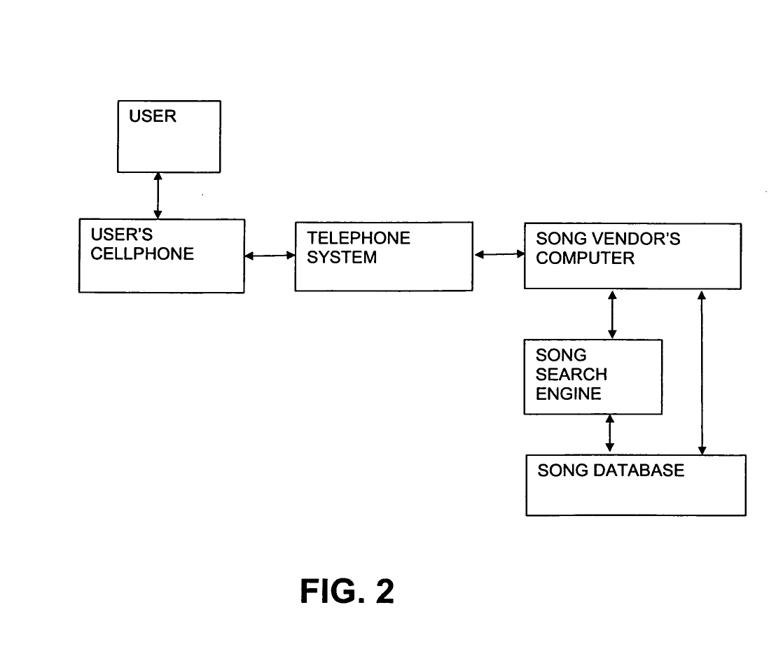

Although the present invention includes the use of Internet-based music sales, it is not limited to this medium. More specifically, the present invention also has the potential to be used over telephone systems, in which case the user might use a cellphone to enter the song melody as well as to download the song. See FIG. 2. And the present invention can be used with other data transmission systems as well. In essence, the present invention may be used in substantially any situation in which at least a portion of a music melody is known and the user desires to identify the song, e.g., by title.

### MODIFICATIONS

It will be understood that many changes in the details, materials, steps and arrangements of parts, which have been herein described and illustrated in order to explain the nature of the invention, may be made by those skilled in the art without departing from the principles and scope of the present invention.

What is claimed is:

1. A method for identifying a song, by obtaining a user-supplied melody and searching a music database using the same.

2. A method according to claim 1 wherein the user-supplied melody is produced by user singing.

3. A method according to claim 1 wherein the user-supplied melody is produced by user humming.

4. A method according to claim 1 wherein the user-supplied melody is produced by user whistling.

5. Apparatus for identifying a song, by obtaining a user-supplied melody and searching a music database using the same.

6. A method for a user to buy a song from a remote music source, the method comprising the steps of:
the user inputting a song melody into an input device connected to the remote music source, wherein the user inputs the song melody using only their mouth;
processing the tones of the input song melody so as to determine a set of tonal characteristics associated with the input tones;
searching a music database for a song having a like set of tonal characteristics, so as to return at least one candidate song title to the user;
playing a sample of the song associated with the at least one candidate song title for the user;
permitting the user to purchase the song associated with the at least one candidate song title if desired; and
delivering a purchased song to the user via a digital transmission medium.

7. A method according to claim 6 wherein the set of tonal characteristics are expressed in the context of an absolute note scale.

8. A method according to claim 6 wherein the set of tonal characteristics are expressed in the context of absolute frequency.

9. A method according to claim 6 wherein the set of tonal characteristics are expressed in the context of a rise, fall or repeat of the frequency of immediately-preceding tone.

10. A method according to claim 6 wherein the digital transmission medium comprises the Internet.

11. A method according to claim 6 wherein the digital transmission medium comprises a telephone system.

12. A method according to claim 6 wherein the digital transmission medium comprises a wireless network.
